(19) United States
(12) Patent Application Publication
(10) Pub. No.: US 2007/0023718 A1
(43) Pub. Date: Feb. 1, 2007

(54) Mud pulser

(75) Inventor: John Robert Menconi, Portland, OR (US)

Correspondence Address: MARK A OATHOUT, 3701 KIRBY DRIVE, SUITE 960, HOUSTON, TX, 77098, US

(73) Assignee: Precision Energy Services, Ltd., Calgary (CA)

(21) Appl. No.: 11/192,782

(22) Filed: Jul. 29, 2005

(51) Int. Cl. F16K 47/00

(52) U.S. Cl. 251/123

(57) ABSTRACT

An MWD/LWD mud pulser orifice for reducing erosion on the discharge side of the orifice has an upstream conduit, a poppet mounted in the upstream conduit reciprocal with respect to the orifice, the orifice is fixed to the upstream conduit having a flow restriction aperture and a discharge side, and a downstream conduit fixed to the discharge side of the orifice has an inner diameter wall. The flow restriction aperture has a center hole plugged by the poppet when the poppet is moved forth into an engaged position, and axial slots integral with and distal from the center hole. The discharge side of the orifice has a smooth transition taper from the center hole to the inner diameter wall in distal regions (excluding the regions of the axial slots).

### CROSS-REFERENCE TO RELATED APPLICATIONS

Not Applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

The illustrated valve in FIGS. 1, 1A and 1B is one embodiment of a prior art mud pulser orifice assembly 100. Pulser is the common name for a tool used in measurement-while-drilling (“MWD”)/logging-while-drilling (“LWD”) operations. The illustrated valve is basically an automated valve that creates pressure waves in the fluid column which can be decoded on surface, and may be referred to as one type of a “pulser”. The illustrated valve closes by moving a poppet (not shown) into the plain orifice 110 to close off flow from the center hole 112 allowing flow through the orifice slots 114 only (see FIG. 1A).

As fluid exits a flow restriction 116, from such a plain orifice 110, there is an abrupt expansion (i.e. fluid will separate from the primary flow stream traveling through the center hole 112 and expand on the discharge side 118 of the plain orifice 110 to fill the area on the discharge side 118). The step 120 on the discharge side 118 of the plain orifice 110 allows free expansion creating a torus shaped region of swirling flow 122. This swirling fluid has increased local velocities and erratic flow direction relative to the primary flow stream exiting the plain orifice 110. Fluid flow will slowly reorganize as it travels away from the restriction 116 until it recovers to a uniform and stable flow profile. However, due to the increased velocity and erratic flow in this swirling flow region 124, components located in this area are susceptible to erosion damage. Additionally, this swirling flow causes a high pressure loss in the pulser. The pressure loss may be attributable to the quanta of incremental fluid expansion which occurs on the discharge side of the orifice. Generally rig operators want to minimize the total pressure loss through the drill string (this includes the bit, motor, MWD/LWD, jars, stabilizers, pipe, etc) so reducing the overall pressure loss through the MWD/LWD tool is desirable (see paragraph [0020] below for additional information related to pressure loss).

Severe damage is caused by the torus shaped region of swirling flow that surrounds the primary flow stream exiting the plain orifice 110. The fluid and abrasive solids spinning in this torus have a high velocity and high impingement angle relative to the tool ID. This results in material removal from the tool ID which can occur very fast if the conditions are right (high velocity and high concentrations of sand for example).

These problems which have been occurring in the industry for many years are typically addressed by estimating the location of erratic flow and protecting the area with erosion resistant materials, parts and/or coatings.

Erosion resistant materials include work hardening types known for cavitation erosion resistance. Such materials may be used in sleeves placed on the downstream side of the orifice. The coatings are not very effective for this type of problem because of thickness limitations. Plus, once the coating is violated (usually only a small pin hole through the coating is necessary) the base material can be eroded very quickly producing cavernous voids behind the coating.

### BRIEF SUMMARY OF THE INVENTION

An MWD/LWD mud pulser orifice for reducing erosion on the discharge side of the orifice in one embodiment has an upstream conduit, a poppet mounted in the upstream conduit reciprocal with respect to the orifice, the orifice is fixed to the upstream conduit having a flow restriction aperture and a discharge side, and a downstream conduit fixed to the discharge side of the orifice has an inner diameter wall (the poppet may also be fixed in the upstream conduit and the orifice could move over the poppet). The flow restriction aperture has a center hole plugged by the poppet when the poppet is moved forth into an engaged position, and axial slots integral with and distal from the center hole. The discharge side of the orifice has a transition taper from the center hole to the inner diameter wall in distal regions (excluding the regions of the axial slots).

### BRIEF DESCRIPTION OF THE SEVERAL VIEWS OF THE DRAWINGS

FIG. 1 is a schematic view of a prior art plain mud pulser orifice (represented in an open condition).

FIG. 1A is a view looking into the direction of flow for a prior art plain orifice.

FIG. 1B is a view taken along line 1B-1B of FIG. 1A.

FIG. 2 is a schematic view of an embodiment of a mud pulser orifice (represented in an open condition).

FIG. 3 is a graph comparing the pressure loss in profiled mud pulser orifice assembly vs. a prior art plain mud pulser orifice assembly.

FIG. 4 is a perspective view of one embodiment of a mud pulser orifice assembly (shown with the valve opened).

FIG. 5 is a view looking into the direction of flow for one embodiment of a mud pulser orifice.

FIG. 6 is a view taken along line 6-6 of FIG. 5.

FIG. 7 is a perspective view from the entry side of one embodiment of an orifice.

FIG. 8 is a perspective view from the discharge side of the orifice shown in FIG. 7.

FIG. 9 is a schematic view of another embodiment of a mud pulser orifice.

FIG. 10 is a schematic view of another embodiment of a mud pulser orifice.

### DETAILED DESCRIPTION OF THE PREFERRED EMBODIMENT(S)

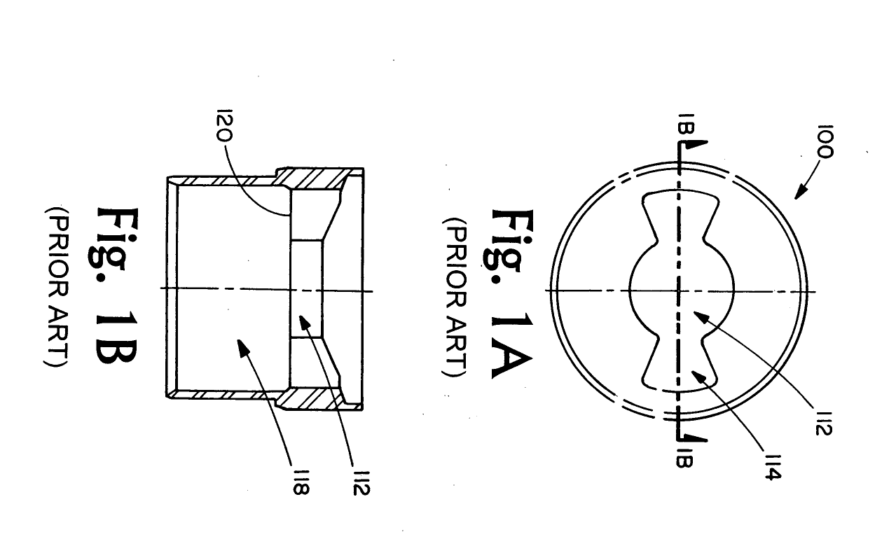

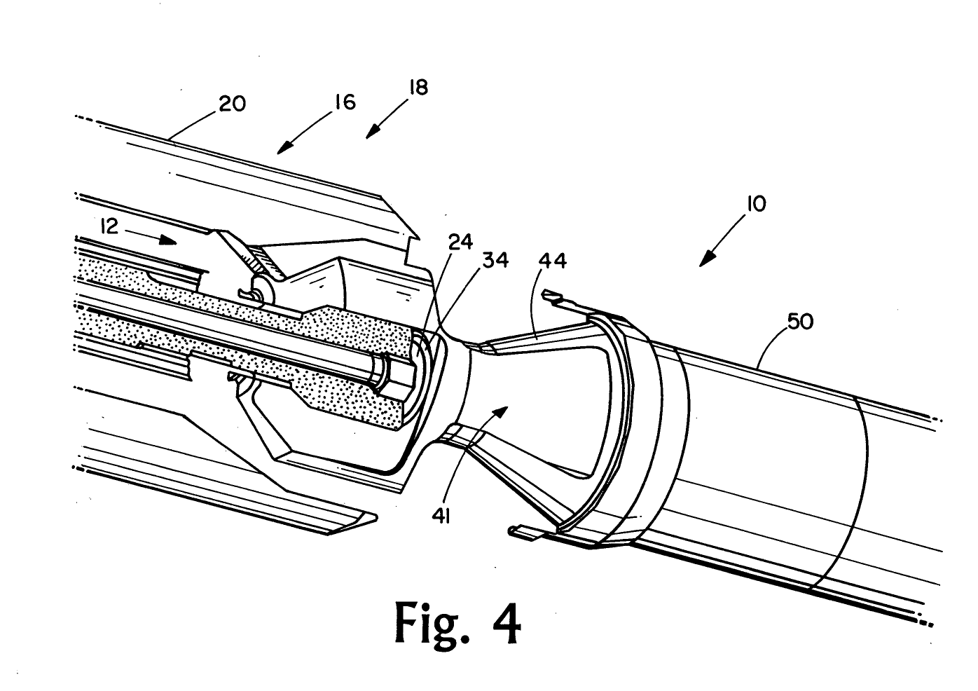

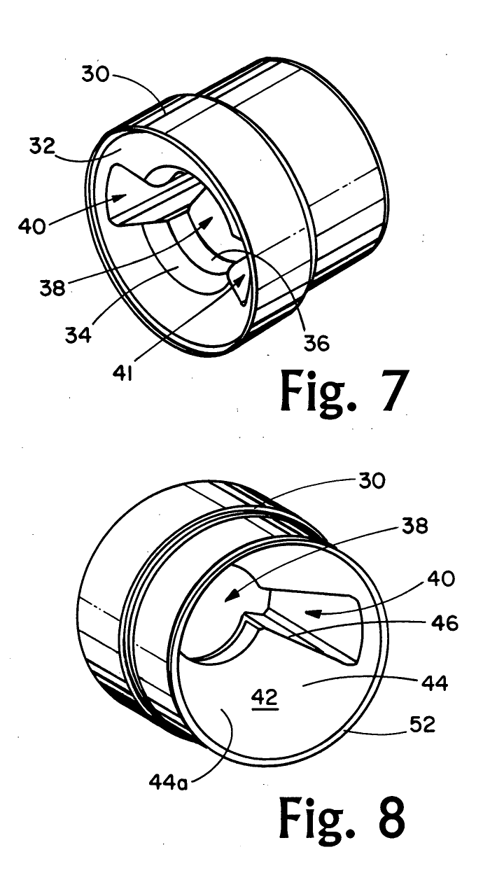

Referring to FIGS. 2, and 4-8, a mud pulser assembly 10 for MWD or LWD is shown. The mud pulser assembly 10 is for use in a telemetry system wherein pulses are transmitted upwardly through a column of drilling fluid being circulated downwardly through a drill string 18 and out a bit (not shown) to an annulus. The mud pulser assembly 10 generally has an upstream conduit 20, an orifice 30 and a downstream conduit 50. The upstream conduit 20 and the downstream conduit 50 may be part of a tubular body 16 used in the drill string 18. Fluid flow is from left to right as depicted in the drawings.

The upstream conduit 20 defines an upstream flow channel 22. A poppet 24 is mounted in the upstream flow channel 22 within the conduit 20. The poppet 24 is reciprocal with respect to upstream conduit 20 and with respect to the orifice 30. Various mechanisms for making the poppet 24 reciprocate within the upstream conduit 20, and back and forth from orifice 30, are known to one of ordinary skill in the art.

The orifice 30 has an entry side 32, a flow restriction aperture 36 and a discharge side 42. The entry side 32 may have a seat 34 for receiving the poppet 24.

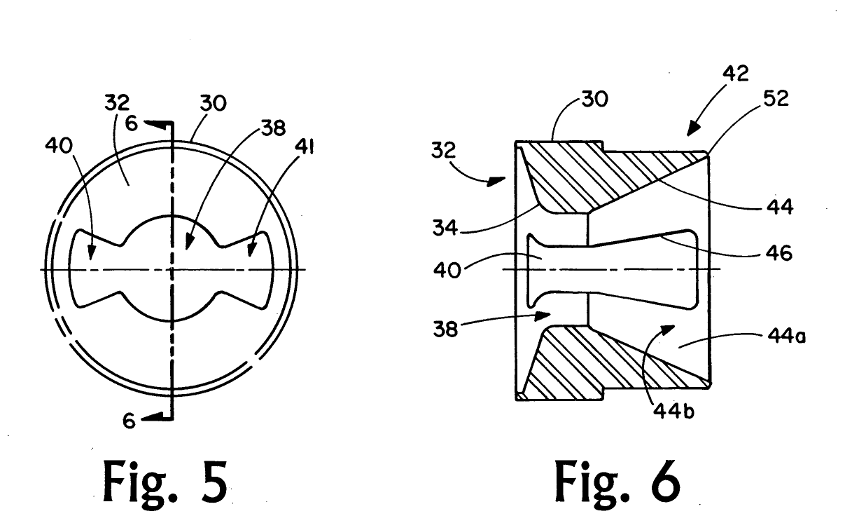

The flow restriction aperture 36 has a center hole 38 and axial slots 40, 41 (FIGS. 5-8). The axial slots 40, 41 are integral with the center hole 38, and distal with respect to the center hole 38. The slot widths vary to accommodate different operating conditions (flow rate, fluid density, etc). Two axial slots 40, 41 are represented, however the orifice 30 could have more or less than two axial slots 40, 41.

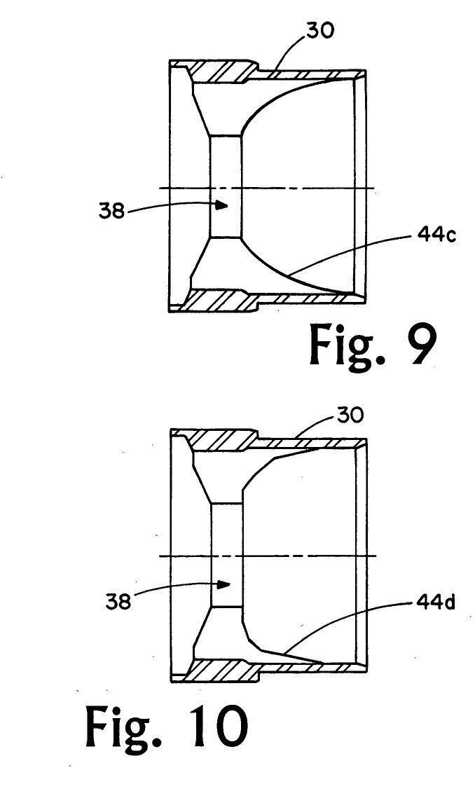

The discharge side 42 of the orifice 30 has a taper or oblique surface 44. The taper 44 functions to decrease fluid separation as compared to the prior art plain orifice 110. The taper 44 runs from the center hole 38 to the inner diameter wall 52 of the downstream conduit 50. The taper 44 may be defined as a substantially frusto-conical surface 44a although other types of tapers may be implemented, such as, for example, an arcuate taper 44c (see FIG. 9) which may be either concave or convex and could be frusto-parabolic, or, for example, a series of contiguous oblique surfaces 44d (see FIG. 10) such as the transition is ninety degrees for a short distance, next it changes to an intermediate sixty degree slant, then a thirty degree slant, and ends at a slant less than thirty degrees. The frusto-conical surface 44a defines a frusto-conical flow passage 44b (which may for example be defined by incrementally increasing a flow passage radius as flow progresses through the discharge side 42 of the orifice 30) it being understood that tapers like surfaces 44c or 44d would define a different shaped flow passage. A straight taper 44 preferably runs at an angle or any combination of angles greater then zero but less then ninety degrees (with extreme angles, like eighty-five degrees, only being used in embodiments such as that shown in FIG. 10), preferably an angle within the range between ten to thirty degrees, and most preferably the angle is about twenty degrees in common use. Accordingly, a skilled artisan may adjust the angle of incidence when the constraints of the applicable working device are known. The taper 44 runs outwardly in the downstream axial direction to intersect the inner diameter wall 52 of the downstream conduit 50.

The outer ends of the respective slots 40, 41 are not tapered, i.e. the axial slots 40, 41 run the length of the orifice 30 at approximately the same radius as the downstream flow channel 54. In other words, as shown in FIG. 8, the frusto-conical surface 44a (and frusto-conical flow passage 44b) is discontinuous when the conical surface 44a intersects one of the slots 40, 41, i.e., along a tapered ridge 46 (or, in other words, the projection of the slots 40, 41 in the flow direction onto the frusto-conical surface 44a).

As mentioned previously, the downstream conduit 50 has an inner diameter wall 52. The downstream conduit 50 defines a downstream flow channel 54.

A volume of mud or drilling fluid flows 60 (with flow lines as depicted by arrows in the drawings) through the mud pulser assembly 10 with inlet flow 12 flowing through the upstream conduit 20. Next, the mud flow 60 passes through the flow restriction aperture 36 of orifice 30. If the poppet 24 is moved forth into engagement (or proximity) with seat (or surface) 34 to plug the center hole 38, then the mud 60 flows through axial slots 40, 41. If the poppet 24 is disengaged from the center hole 38, then the mud 60 flows through center hole 38 and the axial slots 40, 41. Those having ordinary skill in the art will understand that such is the mechanism for generating pulses through the mud 60. Then, after exiting the flow restriction aperture 36, the mud 60 flows through the discharge side 42 to the downstream conduit 50 where it becomes outlet flow 14.

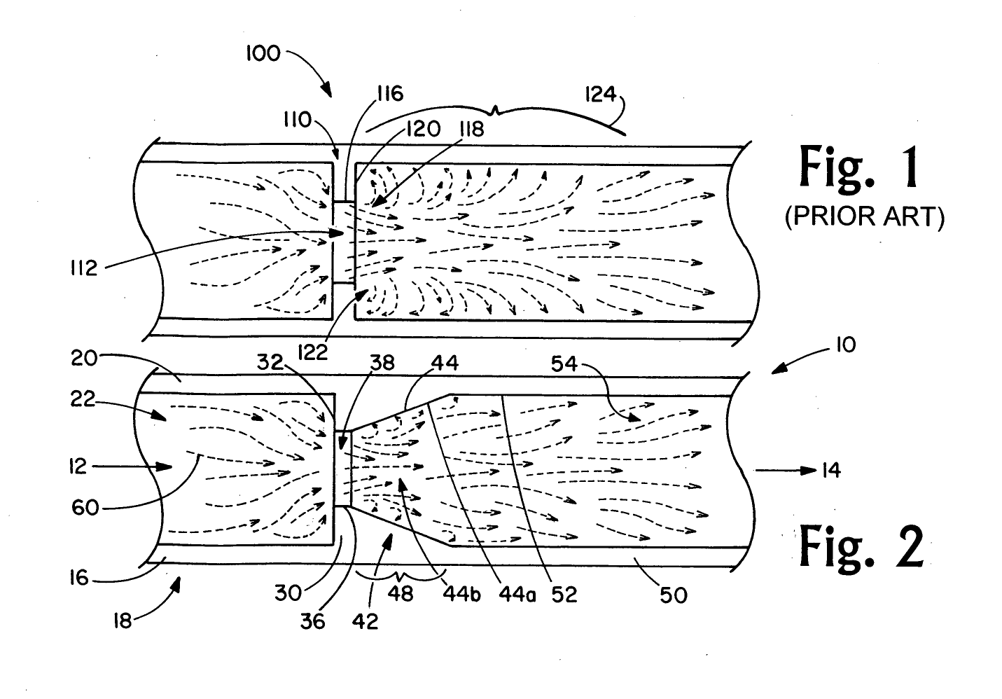

When flowing through the discharge side 42, the mud flow 60 experiences characteristics of expansion. However, by means of the frusto-conical flow passage 44b, fluid expansion is controlled and the torus shaped region of swirling flow 48 is greatly reduced as compared to such flow through a plain orifice 110 (see FIG. 1). As diffuser efficiency increases flow separation decreases. As a result, mud flow 60 can return to a fully recovered condition quickly after exiting the orifice thus reducing exposure to swirling flow and reducing the orifice pressure loss.

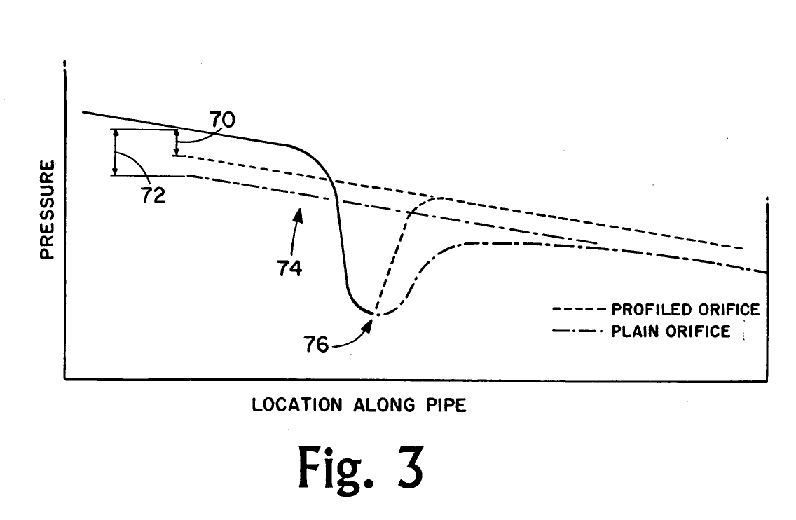

Referring to FIG. 3, the diagram depicts a comparison of profiled (FIG. 2 diffused) vs. non-profiled (FIG. 1 abrupt expansion) pressure loss moving incrementally along the apparatus 10 or 100 (respectively) in the region of the orifice 30 or plain orifice 110, respectively. Notice that both profiled orifice loss 70 and the plain orifice loss 72 have about the same pressure dip in the vicinity of the orifice minimum flow area 74 but the profiled orifice recovers faster resulting in a lower net loss relative to a common node upstream of the orifice 30 or plain orifice 110, respectively. Also, the maximum pressure dip 76 occurs slightly downstream of the orifice minimum flow area. This is called the vena contracta. It represents the minimum effective flow area and is caused by continued contraction of flow as it passes through the orifice 30 or plain orifice 110, respectively.

The mud 60 can be any drilling type fluid as known to one of ordinary skill in the art, such as, for example, a water or oil based drilling fluid. It is typically weighted with a suspended material such as barite and can contain various sorts of formation cuttings. One having ordinary skill in the art is aware of the suppliers and types drilling fluids/mud.

In conclusion, therefore, it is seen that the present invention and the embodiments disclosed herein are well adapted to carry out the objectives and obtain the ends set forth. Certain changes can be made in the subject matter without departing from the spirit and the scope of the invention(s). It is realized that changes are possible within the scope of the invention(s) and it is further intended that each element or step recited is to be understood as referring to all equivalent elements or steps. The description is intended to cover the invention(s) as broadly as legally possible in whatever form it may be utilized.

1. A mud pulser apparatus for reducing erosion on a discharge side of the apparatus, comprising:
an upstream conduit;
a poppet mounted in the upstream conduit wherein the poppet includes a means for reciprocating the poppet with respect to an orifice;
the orifice defining a flow restriction aperture wherein the orifice is fixed to the upstream conduit;
wherein the flow restriction aperture has a center hole plugged by the poppet when the poppet is moved forth into an engaged position;
wherein the flow restriction aperture has an axial slot integral with and distal from the center hole;
wherein the orifice includes the discharge side;
a downstream conduit having an inner diameter wall, wherein the downstream conduit is fixed to the discharge side of the orifice; and
wherein the discharge side includes a taper from proximate the center hole to the inner diameter wall.

2. The apparatus according to claim 1, wherein said taper is a substantially frusto-conical surface defining a substantially frusto-conical flow passage.

3. The apparatus according to claim 1, wherein said taper runs at an angle of about twenty degrees outwardly in the downstream axial direction to intersect and with respect to the inner diameter wall of the downstream conduit.

4. The apparatus according to claim 1, wherein said taper runs at an angle ranging from about thirty degrees to about ten degrees outwardly in the downstream axial direction to intersect and with respect to the inner diameter wall of the downstream conduit.

5. The apparatus according to claim 1, wherein the flow restriction aperture further includes a second axial slot integral with and distal from the center hole.

6. The apparatus according to claim 2, wherein the flow restriction aperture further includes a second axial slot integral with and distal from the center hole.

7. The apparatus according to claim 3, wherein the flow restriction aperture further includes a second axial slot integral with and distal from the center hole.

8. The apparatus according to claim 4, wherein the flow restriction aperture further includes a second axial slot integral with and distal from the center hole.

9. An apparatus for use in a telemetry system wherein pulses are transmitted upwardly through a column of drilling fluid being circulated downwardly through a drill string, comprising:
a tubular body connectible as part of the drill string and having an orifice through which the fluid may pass;
the orifice including a central opening having a downstream outwardly extending substantially frusto-conical surface which intersects the inner diameter of the tubular body;
a slot extending outwardly after the orifice to the inner diameter of the tubular body to permit fluid to bypass the central opening; and
a poppet mounted in the tubular body for reciprocating back and forth from an upstream end of the central opening in the orifice so as to restrict flow there-through and thereby incite pulses in the column of drilling fluid.

10. The apparatus according to claim 9, further including a second slot extending outwardly after the orifice to the inner diameter of the tubular body to permit fluid to bypass the central opening.

11. The apparatus according to claim 9, wherein said downstream outwardly extending substantially frusto-conical surface runs at an angle of about twenty degrees to the inner diameter of the tubular body.

12. The apparatus according to claim 9, wherein said downstream outwardly extending substantially frusto-conical surface runs at an angle ranging from about thirty degrees to about ten degrees outwardly in the downstream axial direction to intersect and with respect to the inner diameter wall of the downstream conduit.

13. The apparatus according to claim 10, wherein said downstream outwardly extending substantially frusto-conical surface runs at an angle of about twenty degrees to the inner diameter of the tubular body.

14. The apparatus according to claim 10, wherein said downstream outwardly extending substantially frusto-conical surface runs at an angle ranging from about thirty degrees to about ten degrees outwardly in the downstream axial direction to intersect and with respect to the inner diameter wall of the downstream conduit.

15. A method for reducing erosion on a discharge side of a mud pulser apparatus, comprising the steps of:
flowing a mud through an upstream conduit to an inlet to an orifice;
flowing the mud through a flow restriction aperture in the orifice;
reciprocating a poppet forth and away from the flow restriction aperture from a position upstream of the orifice for selectively restricting flow through the flow restriction aperture;
diffusing flow downstream of the flow restriction aperture while flowing the mud through a discharge side of the orifice; and
flowing the mud through a downstream conduit as an outlet from the orifice.

16. The method according to claim 15, wherein said diffusing step is accomplished by incrementally increasing a flow passage radius as flow progresses through the discharge side of the orifice.

17. The method according to claim 16, wherein the incremental increase in the flow passage radius is at about a twenty degree slope.

18. The method according to claim 17, further including bypassing fluid from a central opening to an axial slot through the flow restriction aperture.

19. The method according to claim 18, further including bypassing fluid from a central opening to an axial slot through the flow restriction aperture.

20. The method according to claim 19, further including bypassing fluid from a central opening to an axial slot through the flow restriction aperture.
